(19) United States
(12) Patent Application Publication
(10) Pub. No.: US 2011/0127396 A1
(43) Pub. Date: Jun. 2, 2011

(54) WALL HANGING INVENTORY CONTROL AND PACKAGING SYSTEM

(76) Inventors: Ethan Parker, Kansas City, MO (US); Beverley Parker, (US)

(21) Appl. No.: 12/953,741

(22) Filed: Nov. 24, 2010

Related U.S. Application Data
(60) Provisional application No. 61/283,127, filed on Nov. 30, 2009.

(51) Int. Cl. F16M 13/02; F16B 45/00

(52) U.S. Cl. 248/223.41; 248/220.21; 248/225.21

(57) ABSTRACT

A wall hanging inventory control and packaging system comprises a wall bracket secured on a wall and provided with a rail at a top lip of the wall bracket at a side near the wall; and at least one carrier, each of which comprises a body for accommodating an article or articles and a hook or clip member extending from the body and engaging with the rail so that the at least one carrier may slide along the wall bracket. The wall hanging inventory control and packaging system according to the present invention is able to efficiently use over the floor or ground space and avoid occupying floor or ground space, and each carrier is capable of being placed anywhere along or sliding on the wall bracket so that it is more convenient to organize and take out an article(s) as needed and help reduce time for finding and taking out items by the end-user.

### CROSS-REFERENCE TO RELATED APPLICATION

This application is based on U.S. Provisional Application No. 61/283,127 entitled “Pic-Pack display, inventory control, and packaging system” filed on Dec. 10, 2009 The benefit of the filing date of the Provisional Application is claimed for this application. The entire contents of the Provisional Application are incorporated herein by reference.

### FIELD OF THE INVENTION

The present invention relates to an inventory control and packaging system, and in particular, a wall hanging inventory control and packaging system which connects a wall mounted bracket including a rail with each carrier such as box or peg hook may be hooked over or slide along said rail at the top of the wall mounted bracket so as to conveniently organize and allow access to take out an item or articles for use as needed.

### BACKGROUND OF THE INVENTION

As normally used by an inventory management system or household items storage cabinet and so on, one needs a special receiving apparatus so as to package and or receive items or articles.

At present, a special storage space is normally designed to sit on the ground or as furniture mounted to the wall as the receiving apparatus as required, and consequently the ground space or the inside space of the furniture is occupied and neither is it convenient to take an item or articles out from a receiving apparatus nor to put an article or the articles into the receiving apparatus.

On the other hand, as for the need from retail locations, a manufacturer may package products in a paper or cardboard box specially designed and printed. Each printed paper or cardboard box only corresponds to one product or one SKU of the products resulting in the usage of a large number of packaging boxes for product packaging, and at the same time, the packaging box is usually thrown away so that a cyclic utilization for the packaging box may not be realized and considerable resource and waste occurs after the paper or cardboard box is circulated into the market to the final user.

In summary, in the prior art, there is not provided an inventory control and packaging system which will avoid needless landfill space and provide a convenient way to manage the inventory and have the ability to take out an article or articles at the same time.

### SUMMARY OF THE INVENTION

The present invention is directed to overcome the deficiencies in the prior art and to provide a system capable of implementing an inventory management system in a hanging manner so as to avoid occupying shelf or floor space and to provide a convenient way to manage the inventory and to take out an article or articles for use by the end user.

An objective of the present invention is to provide a wall mounted inventory control and packaging system, comprising of: a wall bracket that can be mounted to a wall and that has a rail at the top lip of the wall bracket, and at least one carrier for example being a box or a container or a peg hook, each of which comprises a body (eg. a compartment) for accommodating the article(s) and a clip member extending from the body that engages with the rail so that at least one carrier may be attached to the rail and this carrier may be slid along or be placed anywhere on the rail that is provided on the wall. This wall bracket also has a level integrally molded into it for ease of mounting.

Preferably, the rail is provided with a rail groove at a lower end thereof and the clip member is provided a protrusion at a lower edge thereof, and the protrusion on the clip member can be inserted into the rail to help secure the carrier on the rail.

Preferably, the clip member on the back edge of the carrier matches the groove on the rail at the top of the wall bracket.

Preferably, the body and the clip member are integrally molded.

Preferably, the wall bracket is composed of at least one wall bracket block, each wall bracket block is provided with the rail at the top edge and in the same position and on each end of the one wall bracket block which another wall bracket block can be mounted to form a continuous rail.

Preferably each bracket block has an interlocking dovetail or similar joint of a recess and an interlocking protrusion at each end thereof, so that a continuous wall bracket is formed by engaging the interlocking recess or the interlocking protrusion of at least one wall bracket block with the interlocking protrusion or the interlocking recess of an adjoining bracket block.

Preferably, the wall bracket is provided with a bubble level in the center thereof that can be used to help level the wall bracket during installation.

Preferably, the wall bracket is provided with a honeycomb to help make the bracket more stable.

Preferably, one option for the body of the carrier is a plastic box.

Preferably, the box is provided with a cover.

Preferably, the box is made of transparent or semi-transparent material.

Preferably, the box is provided with a label rail inside the front thereof for receiving a printing label for identifying an article or articles within the box.

Preferably, the body of the carrier is a peg hook for hanging merchandise and the peg hook comprises: an upright portion from one end of which the clip member extends, and a hanging arm connected to the upright portion along a horizontal direction of approximately 90 degree opposite the vertical hook.

As can be known from the above technical solution, the present invention employs at least one carrier which may freely slide along the wall bracket for carrying an article or articles, and has the following technical effects:

To use the space above the floor, and thus it is efficient to avoid occupying a cabinet or floor space;

The wall hanging inventory control and packaging system can freely slide along the wall bracket for assortment management and also it is more convenient to take out an article or articles for use, and it will shorten time to take out the article or the articles for use.

The other objects, features and advantages of the present invention will be more apparent by way of the description of the preferred embodiments with reference to the drawing. All such additional systems, methods, features, and advantages are intended to be included within this description, within the scope of the invention, and protected by the accompanying claims.

### BRIEF DESCRIPTION OF THE DRAWINGS

FIG. 1 is a perspective view illustrating an embodiment of a wall hanging inventory control and packaging system in an operating state according to the present invention;

FIG. 2 is a cross sectional view of the embodiment of FIG. 1;

FIG. 3 is a front view of an embodiment of a wall bracket in the wall hanging inventory control and packaging system according to the present invention;

FIG. 4 is a perspective view of an embodiment of a carrier or box in the wall hanging inventory control and packaging system according to the present invention; and

FIG. 5 is a front view of peg hook as another embodiment of a carrier in the wall hanging inventory control and packaging system according to the present invention.

### DETAILED DESCRIPTION OF THE PREFERRED EMBODIMENTS

Hereinafter, embodiments of the present invention will be described in details. It should be noted that embodiments described herein are not to limit the present invention but only illustrative.

The general concept of the present invention lies in designing a wall mounted hanging inventory control and packaging system that can be slid or be moved to any position along the rail of the wall bracket so as to solve problems in prior art and uses space more conveniently.

Specifically, the wall hanging inventory control and packaging system provided by the present invention is divided into two parts, i.e. a wall bracket to be mounted on a wall and a carrier for carrying articles. The wall bracket is provided with a rail and the carrier being either a box container or a peg hook that has a clip that engages on the back of the rail.

For the sake of understanding easily, hereinafter the wall hanging inventory control and packaging system provided by the present invention will be illustratively described in conjunction with specific embodiments. However, those skilled in the art may understand that the following embodiments are not to limit the technical solutions of the present invention.

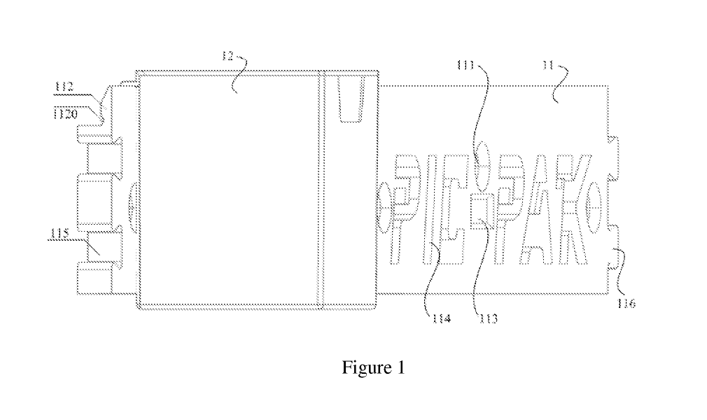

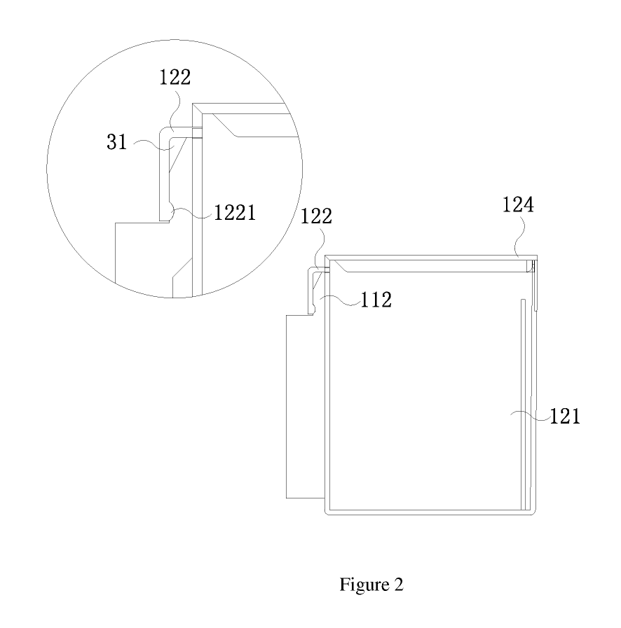

Referring to FIG. 1 and FIG. 2: FIG. 1 illustrates an embodiment of the wall hanging inventory control and packaging system according to the present invention and is a perspective view of the operating state in which a box-shaped carrier 12 is engaged onto the wall bracket 11. FIG. 2 illustrates a cross sectional view of the embodiment of FIG. 1.

Herein, the wall bracket 11 has a plurality of through holes 111, by which the fasteners (such as screws) may secure the wall bracket 11 on a wall.

The wall bracket 11 secured on the wall is provided with an integral rail 112 thereat the top. Wherein the rail 112 may be constructed or obtained by simply removing a part of the structure of the wall bracket 11 at the top of the wall bracket 11 so as to readily engage with the carrier 12. However, as a preferred embodiment, an upper end of the rail 112 may be designed as a tapered wedge-shape, i.e. the upper part is narrow and the lower is wider, in order to conveniently attach the carrier 12, as shown in FIG. 1 and FIG. 2. Therefore a certain space 31 is formed between a clip member 122 of the carrier 12 and the rail 112 when the carrier 12 is engaged on the rail 112, and accordingly the friction force when the carrier 12 slides along the wall bracket 11 is lowered and the carrier is more easily attached.

The carrier 12 comprises a body 121 and the clip member 122 extending from the body 121.

The body 121 is for carrying articles. In this embodiment, the body 121 is box-shaped with a top cover 124 so that an article or articles may be place into the body 121. However, those skilled in the art may understand that other shapes of the body 121 (such as hanger-shaped for hanging an article or articles) or the box-shaped body without a top cover are likewise applicable to the present invention.

The clip member 122 is engaged with the rail 112 of the wall bracket 11, so as to realize that the carrier may be hung on the wall bracket 11 and may slide or be positioned at any place along the wall bracket 11.

The wall hanging inventory control and packaging system provided as described above is designed to organize the items or articles without cluttering the floor or cabinet space and it is convenient to take out the articles for use as needed. The carrier 12 and 22 can be placed or slide along the wall bracket 11.

The card holder label rail 123 is provided inside the front and or back of carrier 12 for receiving a printing card as a label to identify the article(s) within the box including the part number and barcode which can be seen from the outside of the translucent box. This allows one box to be used for multiple items and can be re-used for other items or recycled.

Furthermore, an engineer may optimize the carrier 12 as follows.

In order to avoid the clip member 122 from hanging crooked or unstable due to elastic deformation or up-down movement, the lower end of the rail 112 may be provided with a rail groove 1120 in a horizontal direction to allow the lower edge of the clip member 122 to engage into this rail groove. Therefore, when the clip member 122 is engage with the rail 112, the protrusion 1221 of the clip member 122 may be received into the rail groove 1120, which avoids the clip member 122 from any up-down movement when the clip member 122 slides along the rail 112. Moreover, even if a larger quantity of articles are placed within the carrier 12, the clip member 122 will not fall off of the rail 112 due to deformation caused by the weight of the articles.

Herein, in the embodiment shown in FIG. 1 and FIG. 2, the rail groove 1120 has a grooved recess cross section, and the protrusion 1221 has a protrusion or lip. Therefore, the stability for sliding the clip member 11 on the rail 112 can be maintained when the rail groove 1120 is engaged with the protrusion 1221. However, those skilled in the art may understand that the rail groove 1120 and the protrusion 1221 may be also other engaging shapes, for example, the rail groove 112 may be maintained as an original shape, as above, but the protrusion 1221 may be comprised of a plurality of spherical protrusion spaced apart a certain distance with each other, or the rail groove 1120 and the protrusion 1221 are respectively a rectangular recess and a rectangular protrusion, and so on.

The body 121 and the clip member 122 of the carrier 12 may be independently produced and connected by a manner of rivet, weld, and so on. However, for the purpose of further assuring the hanging stability, the body 121 and the clip member 122 are most preferably integrally molded from plastic.

In addition, the engineer may optimize the wall bracket 11 as follows.

For the sake of conveniently and precisely installing the wall bracket 11, the wall bracket 11 may be provided with a bubble level 113. More preferably, for the sake of convenient observation, the bubble level 113 may be provided at a surface of the wall bracket 11 at a side opposite to the wall. Moreover, the bubble level 113 is preferably provided at a center of the surface of the wall bracket 11 at the side opposite to the wall which is visible during installation.

In order to reduce the weight and maintain the strength of the wall bracket 11, a honeycomb may be provided on the wall bracket, the honeycombed word pattern “PIC-PAK” as shown in FIG. 1 may be used. Particularly, the wall bracket 11 provided with a honeycomb 114, may have better ductility and better horizontal bearing strength in comparison with a solid wall bracket 11.

Moreover, when the wall bracket 11 has enough length, a plurality of carriers 12 may be simultaneously supported and hung on the wall bracket 11. However, in the practical production, it is difficult to predict a length of the wall bracket as practically required and it is more difficult to produce and install the wall bracket 11 if the length of the wall bracket has longer length. Therefore, the wall bracket 11 is preferably composed of at least one wall bracket block, wherein each wall bracket block has an interlocking dovetail joint or other recess and interlocking protrusion at each end thereof, wherein the interlocking recess and the interlocking protrusion are preferably a dovetail joint. Therefore, at least one wall bracket block may be assembled into an integral structure by engaging the interlocking recess or the interlocking protrusion of one wall bracket block with the interlocking protrusion or the interlocking recess of another wall bracket block. Moreover, each wall bracket block is provided with the rail 112 at the same position thereof at a side near the wall, so that when a plurality of the wall brackets are connected, the respective rails of the wall bracket blocks may be also connected together so that a complete and continuous rail is obtained.

In the case that the wall bracket 11 is composed of a plurality of wall bracket blocks, then each wall bracket block may be respectively provided with a bubble level at the center of a side surface thereof opposite to the wall and visible during installation. Moreover, in order to decrease the weight of each wall bracket block itself, each wall bracket may be respectively provided with a honeycomb.

As shown in FIG. 1, the wall bracket 11 is composed of only one wall bracket block, which is provided with an interlocking recess 115 at a left end thereof and an interlocking protrusion 116 at a right end thereof and vice versa which when joined together they make a dovetail joint.

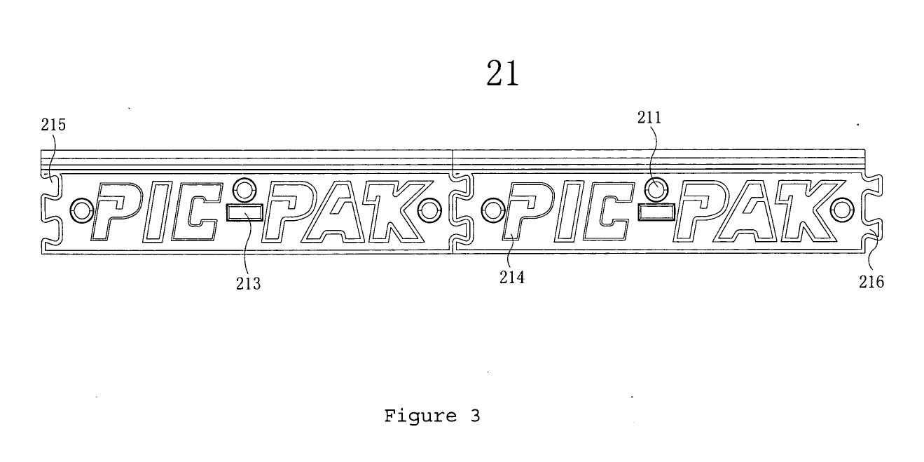

Further, referring to FIG. 3, the wall bracket 21 which is composed of two wall bracket blocks is illustrated. Herein, each wall bracket block is secured on the wall via through holes 211, and provided with an interlocking recess 215 at the left end thereof and an interlocking protrusion 216 at the right end thereof. The interlocking protrusion of a leading end of the wall bracket blocks is engaged with the interlocking recess of an immediately subsequent adjoining wall bracket block, so that the two wall bracket blocks become one integral structure for hanging and sliding the carrier(s). Moreover, each wall bracket block is provided with a bubble level 213 at the center of the surface thereof, and each wall bracket block is provided with a honeycomb 214.

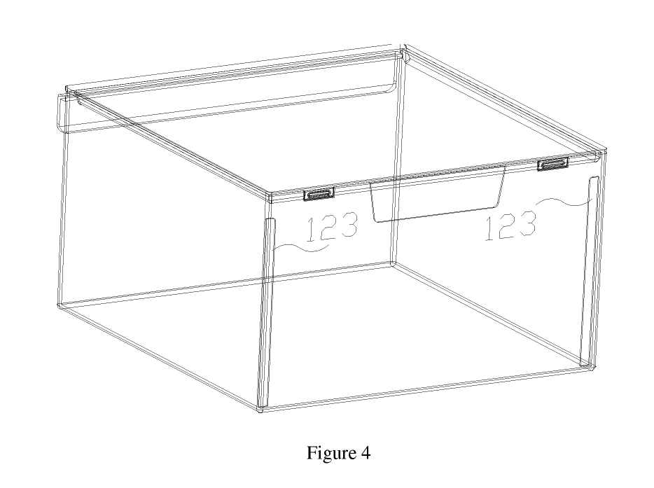

The wall hanging inventory control and packaging system according to the present invention has been described in the above embodiment, herein the body of the associated carrier is a box with a cover, as shown in FIG. 4. Certainly, those skilled in the art may understand that the box without a cover still meets the requirement of the present invention.

However, the box may be preferably made of a semi-transparent or translucent material, such as semi-transparent plastics so that articles in the box can be easily identified.

In particular, the box FIG. 4 is used as packaging of a product or products. However, a difference in comparison with one of the prior art lies in that the box is provided with a label rail 123 inside the front wall of the box for receiving an item specific printing label to identify the article by part number and barcode.

The printing label may be printed with a company logo, a product type, a part number and/or a barcode. When the product is circulated into a market, the transparent or semi-transparent box makes the printing label readable through the plastic and makes the barcode scannable, and thus the product in the box can be identified.

As the article in the box is taken out, the box may be repeatedly used as a receiving box, and at the same time, the printing label may be used to mark a new article by writing the respective information on the reverse side of the printing label by hand. Then, the printing label can be reversed and put into the label rail 123. This makes it possible to repeatedly use the box in the inventory management system as the receiving box.

When the box is used to package products and the wall brackets are sent packaged with the products, this system has an advantages so as to limit the number of printed box containers as the prior art, and to help prevent the products from being lost or damaged.

For the box identifying a product or products with the printing label, a different product may be identified by only replacing the printing label with another printing label. Therefore the box can be used repeatedly. This may cut down on waste from packages specially designed for a particular product. Also, the box may further be used repeatedly as a receiving box, and secondary waste due to repurchase of a receiving box or container may be relieved to a large degree.

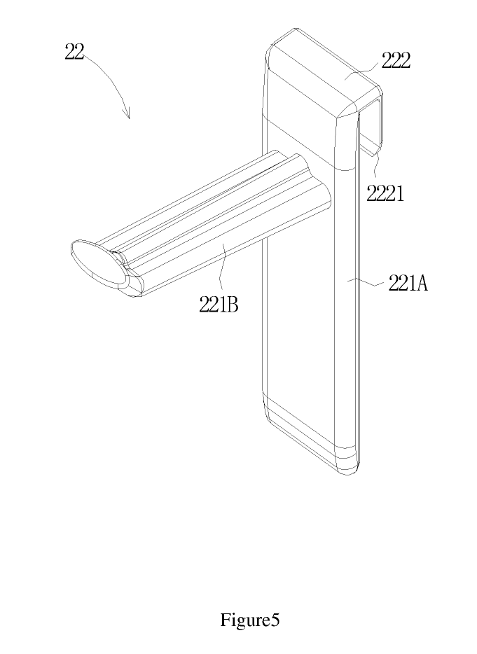

Another embodiment of the carrier in the present invention may be also a peg hook. As shown in FIG. 5, a perspective structural view of such a carrier 22 is illustrated. The peg hook comprises an upright portion 221A, from one end of which a clip member 222 extends, and the clip member 222 is provided with a protrusion 2221 at a lower end thereof. The body 221 further comprises a hanging arm 221B which is connected to the upright portion along a direction horizontally opposite and approximately orthogonal or 90 degrees to the clip member 222.

What is claimed is:

1. A wall hanging inventory control and packaging system, comprising:
a wall bracket mounted on a wall and provided with a rail at a top lip of the wall bracket at a side near the wall, and
at least one carrier, each of which comprises a body for accommodating an article(s) and a clip member extending from the body and engaging with the rail so that at least one carrier may slide along the rail of the wall bracket.

2. The wall hanging inventory control and packaging system according to claim 1, wherein the rail is provided with a rail groove at the lower taper end thereof and the clip member is provided with a protrusion at a lower edge thereof in such a way that these can be engaged to hold the carrier in place

3. The wall hanging inventory control and packaging system according to claim 2, wherein the protrusion on the lower end of the clip member of the carrier and the rail groove on the rail is to help stabilize the carrier

4. The wall hanging inventory control and packaging system according to claim 1, wherein the body and the clip member are integrally molded.

5. The wall hanging inventory control and packaging system according to claim 1, wherein the wall bracket is composed of at least one wall bracket block, each wall bracket block is provided with the rail at the same position thereof at a side near the wall and has an interlocking recess and a dovetail joint or some other type of interlocking protrusion at each end thereof, so that the wall bracket is formed by engaging the interlocking recess or the interlocking protrusion of at least one wall bracket block with the interlocking protrusion or the interlocking recess of at least one other wall bracket block.

6. The wall hanging inventory control and packaging system according to claim 2, wherein the wall bracket is composed of at least one wall bracket block, each wall bracket block is provided with the rail at the same position thereof at a side near the wall and has a dovetail joint or some other type of interlocking recess and an interlocking protrusion at each end thereof, so that a continuous wall bracket is formed by engaging the interlocking recess or the interlocking protrusion of at least one wall bracket block with the interlocking protrusion or the interlocking recess of at least one other wall bracket block.

7. The wall hanging inventory control and packaging system according to claim 5, wherein the wall bracket block is provided with a bubble level at a surface thereof at a side opposite to the wall and visible during instillation to help install the wall bracket horizontally level.

8. The wall hanging inventory control and packaging system according to claim 5, wherein the wall bracket block is provided with a honeycomb.

9. The wall hanging inventory control and packaging system according to claim 1, wherein the body of the carrier is a box.

10. The wall hanging inventory control and packaging system according to claim 2, wherein the body of the carrier is a box.

11. The wall hanging inventory control and packaging system according to claim 9, wherein the box is provided with a cover.

12. The wall hanging inventory control and packaging system according to claim 9, wherein the box is made of transparent or semi-transparent material.

13. The wall hanging inventory control and packaging system according to claim 9, wherein the box is provided with a label rail inside the front thereof for receiving a printing label for identifying an article or articles within the box.

14. The wall hanging inventory control and packaging system according to claim 10, wherein the box is provided with a label rail inside the front thereof for receiving a printing label for identifying an article or articles within the box.

15. The wall hanging inventory control and packaging system according to claim 1, wherein the body of the carrier is a peg hook and the peg hook comprises:
an upright portion from one end of which the clip member extends; and
a hanging arm connected to the upright portion along a direction opposite and approximately orthogonal to the clip member.

16. The wall hanging inventory control and packaging system according to claim 2, wherein the body of the carrier is a peg hook and the peg hook comprises:
an upright portion from one end of which the clip member extends; and
a hanging arm connected to the upright portion along a direction opposite and approximately orthogonal to the clip member.
